(19) United States
(12) Patent Application Publication
(10) Pub. No.: US 2001/0038684 A1
(43) Pub. Date: Nov. 8, 2001

(54) X-ray fluorescence analysis apparatus

(76) Inventors: Yoshiki Matoba, Chiba-shi (JP); Mitsuo Naito, Chiba-shi (JP)

Correspondence Address: ADAMS & WILKS, 31st Floor, 50 Broadway, New York, NY, 10004, US

(21) Appl. No.: 09/827,123

(22) Filed: Apr. 5, 2001

(30) Foreign Application Priority Data
Apr. 6, 2000 (JP) 2000-104846

(51) Int. Cl. G21K 1/02

(52) U.S. Cl. 378/147; 378/44

(57) ABSTRACT

The present invention provides an X-ray fluorescence analysis apparatus in which the collimator, which defines a range of passing X-rays, can be attached to and detached from a housing, an X-ray generator, or an X-ray detector. The collimator has a left-hand thread on a side opposite to the thread and being coaxial with the thread, so that it can be attached to and detached from a thread of an object. It is also capable of being attached and detached easily to and from the housing, the X-ray generator, and the X-ray detector with respect to the inner shape of the housing using a cylindrical jig provided with the left-hand thread.

### BACKGROUND OF THE INVENTION

The present invention relates to a fluorescent X-ray analysis apparatus for detecting secondary X-rays generated by a sample during irradiation with X-rays and carrying out elementary analysis.

An overview of the attachment and the detachment of the collimator of the X-ray fluorescence analysis apparatus with the thread mechanism for attachment and detachment of the collimator of the related art will be described in the following based on FIG. 2.

The collimator 4 is provided with circular indentations at 2 points which are further out than a hole on the collimator and on its diameter, and a jig 5 with a projection fits into the two indentations.

For attachment, the jig is hooked to the indentations of the collimator, the collimator is carried to the mounting point, and the thread section of the collimator is lined up with the thread section of the housing, the X-ray generator, or the X-ray detector, and the jig is then rotated.

For detachment, the projection of the jig is turned so as to line up with the indentation of the collimator, and after the thread has been detached, the indentation of the collimator is hooked onto the projection of the jig and then taken out from the inside of the housing.

However, in the method of the related art, there was a difficulty in rotating when screwing in or screwing out, and there was a danger of the collimator dropping off and damaging the detector, etc. inside the housing when carrying the collimator by hooking the indentation of the collimator with the projection of the jig.

Also, when the mounting position for the collimator was close to the direction in which gravity acts it was difficult to carry the collimator with the jig, making tools such as forceps necessary.

### SUMMARY OF THE INVENTION

In order to resolve the problems, an external left-hand thread is provided coaxial on the opposite side of the side in which the thread of the collimator is formed.

Also, utilizing a jig, having an internal left-hand thread with the same diameter as the external left-hand thread, and a cylindrical shape that is easy to operate with the structure around the mounting position, enables easy attachment and detachment.

Additionally, by providing the indentation (projection) for tightening on the collimator and the projection (indentation) for tightening on the jig, firm attachment is possible.

As mentioned above, in the fluorescence X-ray analysis apparatus in which the collimator is attached and detached by the thread mechanism, it is made possible to attach the collimator to and detach it from the housing, the X-ray generator, or the X-ray detector easily and safely by providing the left-hand thread on the collimator and preparing the cylindrical jig with the left-hand thread of the same diameter.

Firm attachment is also made possible by providing the indentation section and the projection section for tightening on the collimator and on the jig for attachment and detachment.

### BRIEF DESCRIPTION OF THE DRAWINGS

FIG. 1 is a schematic drawing showing the structure of the collimator attachment and detachment mechanism relating to the first embodiment of the present invention;

FIG. 2 is a schematic drawing showing the structure of the collimator attachment and detachment mechanism of the related art;

FIG. 3A is a schematic drawing showing a variation of the collimator attachment and detachment mechanism relating to the first embodiment of the present invention;

FIG. 3B is a schematic drawing showing a variation of the collimator attachment and detachment mechanism relating to the first embodiment of the present invention;

FIG. 4 is a schematic drawing showing the structure of the collimator tightening mechanism relating to the second embodiment of the present invention;

### DETAILED DESCRIPTION OF THE PREFERRED EMBODIMENT

(First embodiment)

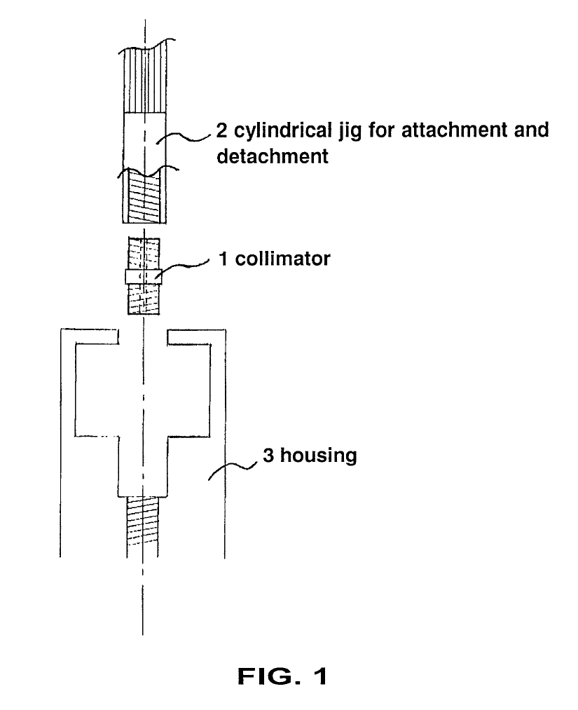

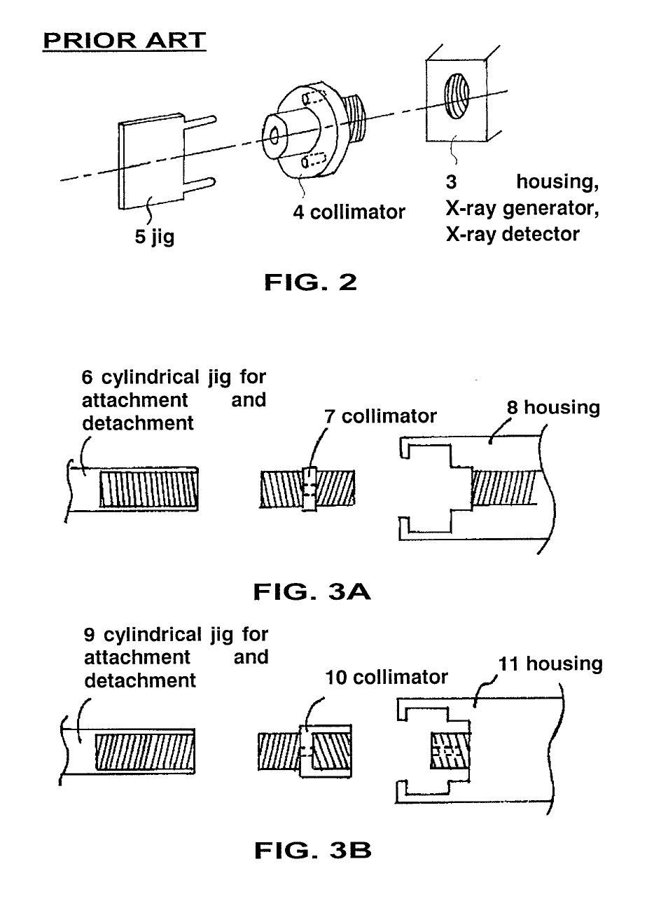

A first embodiment of the present invention will be described in the following based on FIG. 1.

1 is a collimator, and an external thread is cut on a housing attachment side, having a diameter the same as that of the internal thread at the mounting point of the housing.

On the opposite side to the housing attachment side, an external left-hand thread is provided coaxial with the external thread. 2 is a cylindrical jig for attachment and detachment with an internal left-hand thread having the same diameter as the external left-hand thread on the collimator.

The cross-sectional area of the jig 2 is smaller than the entrance area of the housing, and smaller than the area around the collimator mounting point, and it is sufficiently long for the operator to reach and work easily.

For attachment, the collimator is screwed anticlockwise into the jig for attachment and detachment until it stops.

Here, static frictional force is acting between the external left-hand thread of the collimator and the internal left-hand thread of the jig.

The external thread of the collimator is then screwed clockwise into the internal thread of the housing, using the grip part of the jig for attachment and detachment.

Here, the collimator is screwed into the housing until the dynamical frictional force acting between the external thread of the collimator and the internal thread of the housing exceeds the static frictional force.

At the instance when the dynamical frictional force exceeds the static frictional force, screwing of the collimator and the housing is terminated, but if rotation in the clockwise direction is continued, the left-hand threads on the collimator and the jig become disengaged due to the effect of the static frictional force between the collimator and the housing, and so only the collimator can be attached to the housing section easily.

On the contrary, to detach the collimator from the housing, the internal left-hand thread of the jig is aligned with the position of the external left-hand thread of the collimator and rotation in an anticlockwise direction is continued, then the internal left-hand thread of the jig becomes screwed into the external left-hand thread of the collimator by the effect of the static frictional force between the external thread of the collimator and the internal thread of the housing.

The screwing is terminated when dynamic frictional force exceeds the static frictional force, but if rotation in the anticlockwise direction is continued, the threads on the collimator and the jig become disengaged due to the effect of the static frictional force between the collimator and the housing, and can be detached.

Before and after the attachment and the detachment, the collimator and the jig are fixed by the thread, so that accurate carriage of the collimator and accurate positional alignment become possible.

Also, as shown in FIG. 3A, the left-hand thread can be provided between the collimator 7 and the housing 8, and the thread can be provided between the collimator 7 and the jig 6.

As shown in FIG. 3B, for the threads between the collimator 10 and the housing 11, the intern al thread can be provided on the collimator side, and the external thread can be provided on the housing side.

The relationship between the threads of the collimator and the housing in the first embodiment of this invention can be applied to the collimator and X-ray generator attachment and detachment mechanism.

Additionally, the relationship between the threads of the collimator and the housing in the first embodiment of this invention can be applied to the collimator and X-ray detector attachment and detachment mechanism.

(Second Embodiment)

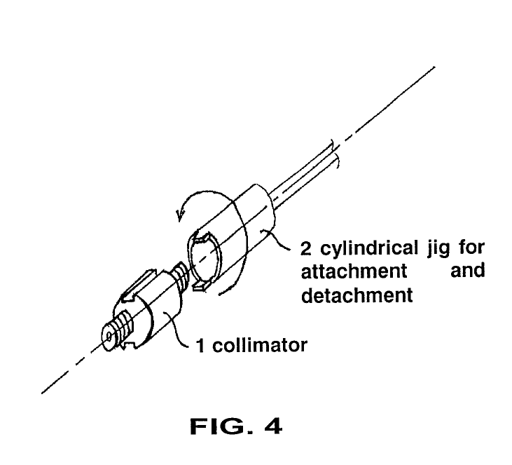

A second embodiment of the present invention will be described in the following based on FIG. 4.

A notch for an indentation is placed at a point symmetrical with a certain point on the outer periphery of the collimator with respect to a central point of the collimator.

A hook of the projection section is also provided on the opposite side to the side having the internal thread of the cylindrical jig for attachment and detachment 2, so as to be lined up with the indentation.

After attaching the collimator to the housing, it is possible to tighten up by aligning the projection of the jig with the indentation of the collimator and rotating in a clockwise direction.

This tightening mechanism is also applicable when the projection is provided on the collimator, and the indentation is provided on the jig.

The mechanism for tightening the threads of the collimator and the housing in the second embodiment of this invention can be applied to tightening of the collimator and the x-ray generator.

Additionally, the mechanism for tightening the threads of the collimator and the housing in the second embodiment of this invention can be applied to tightening of the collimator and the x-ray detector.

In the following, the first embodiment according to the invention will be explained referring to the drawings.

What is claimed is:

1. An X-ray fluorescence analysis apparatus comprising:
an X-ray generator,
an X-ray detector,
a housing,
and a collimator for defining a range for passing X-rays, wherein
a thread is provided on the collimator for attachment to and detachment from the housing,
and a left-hand thread is provided on the opposite side coaxial with the thread for attachment and detachment to and from the housing.

2. An X-ray fluorescence analysis apparatus comprising:
an X-ray generator,
an X-ray detector,
a housing,
and a collimator for defining a range for passing X-rays, wherein
a thread is provided on the collimator for attachment to and detachment from the-X-ray generator,
and a left-hand thread is provided on the opposite side coaxial with the thread for attachment and detachment to and from the X-ray generator.

3. An X-ray fluorescence analysis apparatus comprising:
an X-ray generator,
an X-ray detector,
a housing,
and a collimator for defining a range for passing X-rays, wherein
a thread is provided on the collimator for attachment to and detachment from the X-ray detector,
and a left-hand thread is provided on the opposite side coaxial with the thread for attachment and detachment to and from the X-ray detector.

4. The X-ray fluorescence analysis apparatus disclosed in claim 1, wherein
the collimator is provided with an indentation or projection for tightening.

5. The X-ray fluorescence analysis apparatus disclosed in claim 2, wherein
the collimator is provided with an indentation or projection for tightening.

6. The X-ray fluorescence analysis apparatus disclosed in claim 3, wherein
the collimator is provided with an indentation or projection for tightening.
